(19) United States
(12) Patent Application Publication
(10) Pub. No.: US 2015/0153796 A1
(43) Pub. Date: Jun. 4, 2015

(54) SYSTEM AND METHOD FOR PROTECTING POWER SUPPLY

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: KANG WU, Shenzhen (CN); GUO-YI CHEN, Shenzhen (CN)

(21) Appl. No.: 14/473,181

(22) Filed: Aug. 29, 2014

(30) Foreign Application Priority Data
Dec. 4, 2013 (CN) 2013106455631

(51) Int. Cl. G06F 1/26

(52) U.S. Cl. CPC G06F 1/26

(57) ABSTRACT

A system for protecting a power supply includes a power supply unit (PSU), an integrated baseboard management controller (IBMC), and a platform controller hub (PCH). The IBMC includes a receiving module and a comparison module. When the PSU enters a protection mode and is shut down, but the PCH maintains outputting a power on signal to power on the PSU, the PSU continues outputting a power good signal to the receiving module. The receiving module counts a number of times of receiving the power good signal within a predetermined time period, and outputs the counted number of times. The comparison module compares the counted number of times with a reference value, and outputs a control signal to the PCH when the counted number of times is greater than the reference value. The PCH stops outputting the power on signal to the PSU after receiving the control signal.

### CROSS-REFERENCE TO RELATED APPLICATIONS

This application claims priority to Chinese Patent Application No. 201310645563.1 filed on Dec. 4, 2013 in the China Intellectual Property Office, the contents of which are incorporated by reference herein.

### FIELD

The subject matter herein generally relates to a system and a method for protecting a power supply.

### BACKGROUND

Electronic devices, such as computers and servers, are powered by power supplies.

### BRIEF DESCRIPTION OF THE DRAWINGS

Implementations of the present technology will now be described, by way of example only, with reference to the attached figures, wherein:

FIG. 1 is a diagrammatic view of an example embodiment of a system for protecting a power supply.

FIG. 2 is a flowchart of an example embodiment of a method for protecting a power supply.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like. The term “module”, as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device.

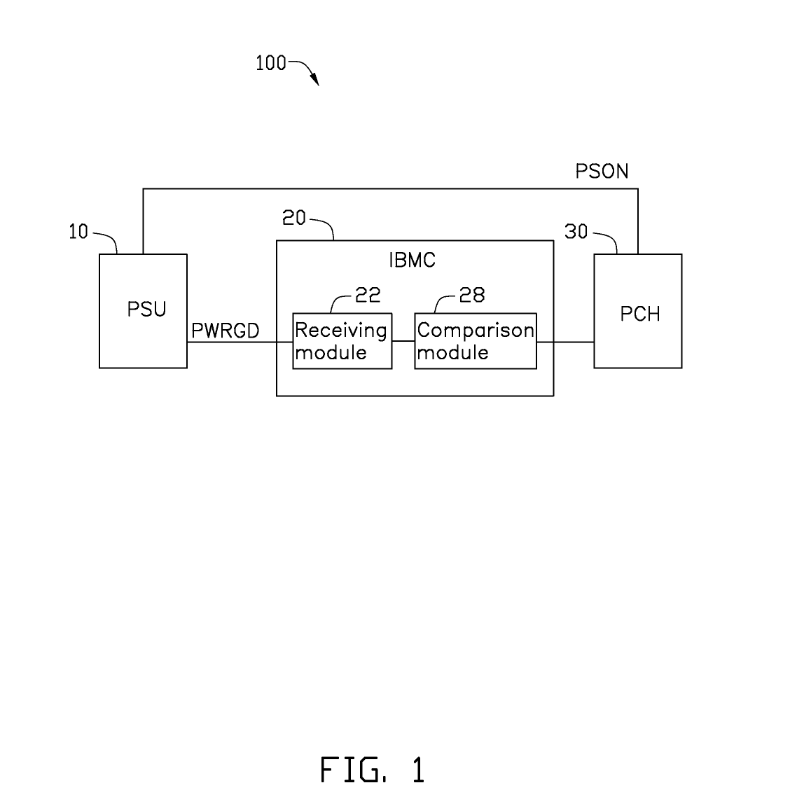

FIG. 1 illustrates an embodiment of a system 100 for protecting a power supply. The system 100 can comprise a power supply unit (PSU) 10, an integrated baseboard management controller (IBMC) 20, and a platform controller hub (PCH) 30. The IBMC 20 can comprise a receiving module 22 and a comparison module 28. The PSU 10 is electrically coupled to the receiving module 22 and the PCH 30. The comparison module 28 is electrically coupled to the receiving module 22 and the PCH 30. In the embodiment, the PCH 30 is configured to output a power on signal PSON to the PSU 10, thus turning on the PSU 10.

The receiving module 22 is used for receiving a power good signal PWRGD from the PSU 10, counting a number of times the power good signal PWRGD is received within a predetermined time period, for example a minute, and outputting the counted number of times to the comparison module 28. The comparison module 28 is used for comparing the counted number of times with a reference value, and outputting a control signal to the PCH 30 when the counted number of times is greater than the reference value. In at least one embodiment, the receiving module 22 and the comparison module 28 can comprise computerized codes in the form of one or more computer-readable programs that are stored in a non-transitory computer-readable medium (not shown) of the IBMC 20. The computerized codes comprise instructions that are executed by a processor (not shown) of the IBMC 20, to provide the aforementioned functions of the system 100.

When the PSU 10 receives the power on signal PSON from the PCH 30, the PSU 10 is powered on and enters a boot state, and checks whether all power supplies of the PSU 10 (i.e., 5V, 12V, 3.3V, or the like) can be output normally. When all the power supplies of the PSU 10 can be output normally, the PSU 10 outputs the power good signal PWRGD to the receiving module 22. Then, the PSU 10 outputs the power supplies to electronic elements (not shown), to power the electronic elements. When an output current of one or more of the power supplies becomes too large, such as when one or more electronic elements short-circuit, the PSU 10 enters a protection mode and is shut down. When the PCH 30 detects that the PSU 10 is shut down, the PCH 30 outputs the power on signal PSON to the PSU 10 a second time, thus causing the PSU 10 to enter the boot state again and check whether all power supplies can be output normally. The PSU 10 outputs the power good signal PWRGD to the receiving module 22 a second time when all power supplies can be output normally. When the PSU 10 is caused to shut down again, the PCH 30 outputs the power on signal PSON a third time to the PSU 10. The PCH 30 continues to output the power on signal PSON if the PSU 10 continues to shut down, until the PCH 30 receives the control signal from the comparison module 28.

The receiving module 22 counts the number of times of receiving the power good signal PWRGD within the predetermined time period, and outputs the counted number of times to the comparison module 28. The comparison module 28 compares the counted number of times to the reference value, and outputs the control signal to the PCH 30 when the counted number of times is greater than the reference value. The PCH 30 stops outputting the power on signal PSON after receiving the control signal. Thus, the PSU 10 is prevented from powering on, and the PSU 10 is prevented from being damaged.

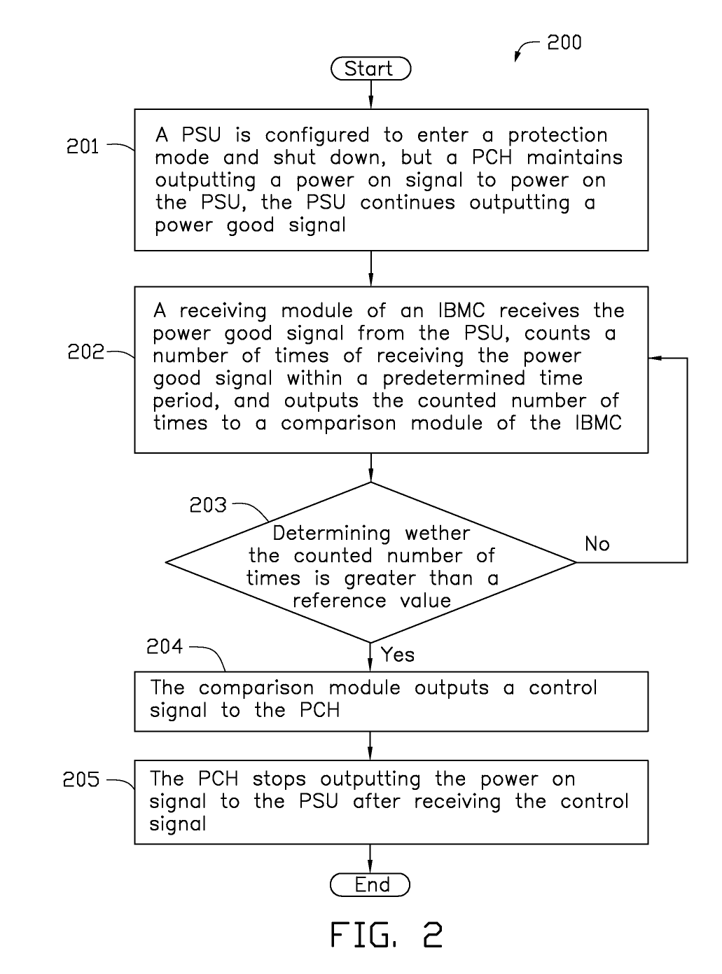

Referring to FIG. 2, a flowchart is presented in accordance with an embodiment of a method 200 for protecting a power supply. The method 200 is provided by way of example, as there are a variety of ways to carry out the method. The method 200 described below can be carried out using the configurations illustrated in FIG. 1, for example, and various elements of FIG. 1 are referenced in explaining example method 200. Each block shown in FIG. 2 represents one or more processes, methods or subroutines, carried out in the example method 200. Furthermore, the illustrated order of blocks is illustrative only and the order of the blocks can change according to the present disclosure. Additional blocks can be added or fewer blocks may be utilized, without departing from this disclosure. The method 200 can begin at block 201.

At block 201, a power supply unit (PSU) is configured to enter a protection mode and shut down, but a platform controller hub (PCH) maintains outputting a power on signal to the PSU to power on the PSU, the PSU continues outputting a power good signal.

At block 202, a receiving module of an integrated baseboard management controller (IBMC) receives the power good signal from the PSU, counts a number of times of receiving the power good signal within a predetermined time period, and outputs the counted number of times to a comparison module of the IBMC.

At block 203, the comparison module compares the counted number of times with a reference value. If the counted number of times is not greater than the reference value, block 202 is repeated. If the counted number of times is greater than the reference value, block 204 is executed.

At block 204, the comparison module outputs a control signal to the PCH.

At block 205, the PCH stops outputting the power on signal to the PSU after receiving the control signal, to avoid the PSU be powered on repeatedly, and to prevent the PSU 10 from being damaged.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A system for protecting a power supply comprising:
a power supply unit (PSU);
an integrated baseboard management controller (IBMC) comprising a receiving module electrically coupled to the PSU, and a comparison module electrically coupled to the receiving module; and
a platform controller hub (PCH) electrically coupled to the PSU and the receiving module;
wherein the PSU is configured to enter a protection mode and shut down, but the PCH maintains outputting a power on signal to the PSU to power on the PSU, wherein the PSU continues outputting a power good signal to the receiving module;
wherein the receiving module receives the power good signal, counts a number of times of receiving the power good signal within a predetermined time period, and outputs the counted number of times to the comparison module;
wherein the comparison module compares the counted number of times with a reference value, and outputs a control signal to the PCH in response to the counted number of times being greater than the reference value; and
wherein the PCH stops outputting the power on signal to the PSU after receiving the control signal.

2. A method for protecting a power supply comprising:
a. a power supply unit (PSU) is configured to enter a protection mode and shut down, but a platform controller hub (PCH) maintains outputting a power on signal to the PSU to power on the PSU, the PSU continues outputting a power good signal;
b. a receiving module of an integrated baseboard management controller (IBMC) receives the power good signal from the PSU, counts a number of times of receiving the power good signal within a predetermined time period, and outputs the counted number of times to a comparison module of the IBMC;
c. the comparison module compares the counted number of times with a reference value;
d. the comparison module outputs a control signal to the PCH in response to the counted number of times being greater than the reference value; and
e. the PCH stops outputting the power on signal to the PSU after receiving the control signal.

3. The method of claim 2, further comprising: in response to the times being not greater than the reference value, b is repeated.
